(19) United States
(12) Patent Application Publication
(10) Pub. No.: US 2013/0168280 A1
(43) Pub. Date: Jul. 4, 2013

(54) ORAL VETERINARY PREPARATIONS

(71) Applicants: Adrian Vos, Lorgues (FR); Peter Schuster, Dessau-Rosslau (DE); Klaus Borowski, Dessau-Rosslau (DE)

(72) Inventors: Adrian Vos, Lorgues (FR); Peter Schuster, Dessau-Rosslau (DE); Klaus Borowski, Dessau-Rosslau (DE)

(73) Assignee: IDT BIOLOGIKA GMBH, Dessau-Rosslau (DE)

(21) Appl. No.: 13/822,015

(22) PCT Filed: Sep. 10, 2011
(86) PCT No.: PCT/EP2011/065698

§ 371 Date: Mar. 11, 2013

Related U.S. Application Data
(60) Provisional application No. 61/403,100, filed on Sep. 10, 2010.

(30) Foreign Application Priority Data
Sep. 10, 2010 (EP) 10176308.4

(51) Int. Cl. A61D 7/00

(52) U.S. Cl. CPC A61D 7/00
USPC 206/438

(57) ABSTRACT

The present invention relates to a container for storing veterinary preparations and administering veterinary preparations contained therein to a target animal species, especially for the oral delivery of active therapeutic agents to free-roaming animals.

Described is also a bait for animals comprising at least one container surrounded by an encasement or a carrier, made from material having a texture that is at least soft or bendable or elastic or resilient at ambient temperature and wherein the container surrounded by the carrier is also made from material having a texture that is at least soft or bendable or elastic or resilient at ambient temperature.

The bait contains in the carrier and/or on the surface of the container at least one additive enhancing the cohesion of carrier and container.

In the bait there is at least one container is in form of single isolated container or two or more containers are present that are isolated or adhered to each other or are physically connected to each other or are connected to each other in form of a chain-like configuration.

The bait can be easily adapted to many animal species and to a specific oral delivery of the active components.

The present invention relates to a container for storing veterinary preparations and administering veterinary preparations contained therein to a target animal species, especially for the oral delivery of active therapeutic agents to free-roaming animals.

It is a constant challenge to administer veterinary preparations to animals, especially to free-roaming animals. On one side it is for example under certain circumstances important to perform vaccinations, on the other side it is rather difficult to administer vaccines to animals that cannot be easily restrained (wildlife, free-roaming domesticated animals, zoo animals, etc.). In order to solve this constant challenge it is necessary to provide veterinary preparations adapted to the certain use or therapy and to a certain target animal. One possible way to solve this challenge is the oral delivery of the veterinary preparations. Usually, the medication for animals is provided in form of a bait that is accepted by the animal in a way that the medication inside of the bait is taken up by the animal as well.

Oral vaccination of wildlife against rabies has shown great success in several regions in the world. For example, oral vaccination of foxes and raccoon dogs has eliminated terrestrial wildlife rabies from West- and Central-Europe. Also, other vector species have been successfully vaccinated against rabies by means of distribution of baits containing a rabies vaccine; for example gray foxes (Texas, USA), coyotes (Texas, USA), and golden jackals (Israel). This novel approach in wildlife disease management has resulted in the development of (experimental) baits against other wildlife diseases. For example, besides oral rabies vaccine baits, baits are momentarily commercial available for foxes against Echinococcus multilocularis and for wild boars against classical swine fever (CSF). Presently, also oral vaccine baits targeted at other disease are under development, for example for badgers against bovine tuberculosis. However, the results obtained with the present available baits have been less successful when applied to other animal species; for example oral vaccination of domestic dogs (Golan Heights, Israel) and raccoons (USA) against rabies.

Several factors can be identified for these failures: first of all the lack of vaccine efficacy for particular animal species, secondly bait availability to the target species is insufficient (vaccine bait distribution system) and finally the vaccine bait used is unsuitable for the target species.

With the exception of the coated sachet bait produced by Merial (Athens, USA) most commercial available (rabies) baits are composed of a hard, solid bait matrix (partially) surrounding the vaccine container.

This kind of bait may be very successful for animal species like foxes and jackals but is not necessarily so for other kinds of animals from an anatomical and/or feeding behavioural perspective.

A major drawback of baits with a hard, solid texture is the fact that especially smaller animals that can or do not take the whole bait in their mouth will start biting in the bait at the edges with the result that the solid bait matrix falls apart in pieces and the vaccine container is separated from the bait. Other animal species are very delicate feeders and will ‘assess’ the food prior to consumption; as soon as the animal encounters resistance when biting into the bait, it will try to separate the vaccine container from the bait. Therefore, firm non-bendable vaccine containers will easily be detected by the animals, increasing the risk that the animals will remove the vaccine container without vaccine release within the mouth cavity. Finally, due to the lower limitations on vaccine amount the vaccine containers and subsequently vaccine baits are for certain animal species or subpopulations (young and juveniles) of these too big. Hence, the capsule is often only partially taken into the mouth, consequently when perforated the vaccine will often be spilled.

EP-A 0 240 826 discloses a bait for animals containing a carrier substance and a vaccine against rabies. The carrier substance contains a fat component and fish meal as a lure substance. The vaccine is contained in a blister of hard plastic covered with aluminium foil. The disadvantage of the bait is that the fat is rather brittle especially at lower ambient temperature. Another backlog is the rather stiff vaccine container.

DE-A 44 20 438 discloses a bait for animals. An active ingredient is packed into a container and is covered by a carrier. The carrier itself is covered with a lure for attracting animals.

A bait for animals is also disclosed in DE-A 42 33 625. A polymeric carrier is admixed with an active ingredient in liquid or solid form. The resulting mixture is used in form of tablets or balls. Herein the active ingredient is not contained in a separate container.

Further attempts to optimize the bait structure are disclosed in U.S. Pat. No. 5,527,531, U.S. Pat. No. 4,666,717, and U.S. Pat. No. 5,747,063. Herein several problems are disclosed with respect to delivery systems to deliver biologics to animals. Synthetic baits are described for the use in different fields of applications to target animal species.

It is an object of the present invention to avoid the disadvantages of baits according to the state of the art. The main backlog of the baits in the art is that the container with the active ingredient can be easily separated by the animal. The animal will then refrain from taking up the foreign material that was hidden in the bait. It has been shown that many animals investigate any food intensively before consuming the same.

This invention describes certain characteristics and other optional features of a universal container to increase the qualitative and quantitative availability of an active therapeutic ingredient for oral delivery. The container can further be optimized for its specific purposes and needs. For example, an additional substance can be incorporated in or on the container that makes it highly unattractive for certain non-target species, thus increasing availability to the target species (e.g. propylene glycol acts as an aversive stimulus to certain rodent species). On the other hand, additional substances can be incorporated to increase detection and thereby uptake by the target species. This can be achieved, for example, by adding certain colorants to increase detection for target species that locate food-items by, among others, visual clues (e.g. corvids, certain non-human primates). Also the size of the container and/or, if required, the encasement can fluctuate depending on the size of the target species and its feeding behaviour. Certain larger canid species like dogs and wolves are used to devour food items without chewing, especially when feeding together with con-specifics. In case the active ingredient must be released in the mouth cavity to induce its therapeutic effect, the container must be punctured, perforated or otherwise ruptured in the mouth cavity. Hence, by adapting the size of the container and/or, if required, encasement the risk that the active ingredient is not released in the mouth cavity is reduced. On the other hand, if the active ingredient must preferably be released in the gastro-intestinal tract, the size of the container or the multiple containers can be reduced to such an extent that it will not be punctured, perforated or otherwise ruptured in the mouth cavity when consumed. In case of many diseases especially infectious diseases it is known that certain subpopulations of the target species are the major transmitters of the disease, for example male animals or adults. By increasing or decreasing size also certain subpopulations of the target species can be specifically targeted or excluded. Also, by including certain substances in or on the container a sex-biased attractiveness can be obtained.

The problem in the state of the art to be solved by the present invention is that in the state of the art the veterinary preparation itself is not optimized for the certain use to a certain target animal species. The present invention is therefore directed to a container for storing veterinary preparations and administering the same to a target animal species. The present invention is also directed to a veterinary preparation that is optimized for the intended use and path of administration of the active ingredient present in the veterinary preparation. The present invention provides a novel concept for administering active ingredients to animals.

Beside the administration of vaccines to animals there is a great demand for a delivery system for especially free-roaming animals in order to apply active therapeutic agents to the same. These active therapeutic agents or ingredients may be selected from contraceptives or vaccines or biologics and the like. Many of these active therapeutic agents or ingredients are sensitive to oxygen or light or humidity so that they can not be admixed in substance to a bait. In the case of free-roaming animals it is often rather difficult to apply active therapeutic agents by injection via a tranquilizer gun, for example. The same applies to the control of population of free-roaming animals be administering contraceptives. A further problem arising is to maintain stability of the active therapeutic agent and the sterility of the veterinary preparation.

Based on experimental studies the inventors have developed a novel type of container for storing veterinary preparations and administering veterinary preparations contained therein that can be used for many different animal species and that circumvents the above mentioned problems. The container may be surrounded by an encasement. This encasement with the container inside can act as a bait and the structure of the encasement is also adapted for the intended use.

The problems of the state of the art are solved according to the present invention by providing a container with the features as given in the main claim. Advantageous embodiments of the present invention are described in the dependent claims.

An object of the present invention is a container for storing veterinary preparations and administering veterinary preparations to a target animal species, wherein the container incorporates the veterinary preparation and wherein the container is adapted to present the container to the target animal species in a way that enhances or optimizes the oral delivery of the veterinary preparation to the target animal species.

The container according to the present invention is characterized in that the container is made from material having a texture that is at least soft or bendable or elastic or resilient at ambient temperature. These materials are preferably used in the form of foils.

The container according to the invention is further characterized in that said material is selected from artificial organic or inorganic polymers, biopolymers, modified biopolymers, metals and composites thereof. Suitable materials can be also selected from polystyrene micro spheres, poly(lactic-co-glycolic acid) (PLGA), sodium alginate, chitosan and the like and from modifications thereof. Especially preferred are biodegradable polymers like polycaprolactone, polyglycolide, polylactic acid, poly-3-hydroxybutyrate and the like together with modifications thereof.

According to the invention it is preferred that the container has an inner surface intended to be in contact with the veterinary preparation and an outer surface wherein at least a part of the outer surface is modified and/or is made from or covered with a different material than the inner surface.

The modification of an outer surface of the container is performed by laminating the surface with paper adhered thereto. Thereby the feel of the surface can be changed to the warm feel of paper. Furthermore the outer surface of the container can be laminated with non-woven fabrics using for example adhesives.

The surface can be modified by flock-coating of the material. For flock-coating the material to be coated is contacted with small fibre particles that adhere to the surface of the material. Adhesion can be accomplished by using adhesives or by making use of electrical fields and electric charging.

Additionally the modification of the surface can be achieved during deep drawing of the surface material by implementing structures in the surface film.

The surface can be modified by changing the polarity of the surface. For example the surface of a film can be made more hydrophobic by treatment with preparations containing silanes, siloxanes or silicones.

Changing the surface to become more hydrophilic can be done by corona treatment in exposing the surface material to a strong electrical field whereby the polarity of the surface is enhanced.

Furthermore the surface energy and reactivity of the surface material can be enhanced by using flame or plasma technologies. The activated surfaces can be more easily coated and the cohesion of the surface can be enhanced by this treatment.

It is further preferred that the modification of the surface or the different material of the surface causes a change in the surface characteristics, wherein the characteristics are selected from adhesion, cohesion, hardness, roughness, surface feel, optical aspect, odour and/or taste.

The container according to the invention is further characterized in that the veterinary preparation is selected from biologics, contraceptives, pharmaceuticals or veterinary drugs or a combination thereof.

According to the invention it is preferred that the veterinary preparation comprises optionally physiologically acceptable additives, adjuvants or excipients or combinations thereof.

According to the invention it is especially preferred that at least one additive is a viscosity modifier.

The container according to the invention is further characterized in that the veterinary preparation comprises further a palatable acceptable additive selected from sugars, sweeteners, salt, natural flavourings, artificial flavourings or combinations thereof.

The container according to the invention is preferably further characterized in that the veterinary preparation is in form of a high viscous fluid or a paste-like fluid.

The container according to the invention is also characterized in that the change in the surface characteristics is provided by the addition of a palatable acceptable additive selected from sugars, sweeteners, salt, natural flavourings, artificial flavourings or combinations thereof.

It is according to the invention especially preferred that on the surface of the container at least one component is present enhancing the cohesion.

It is thereby especially preferred that said component is selected from hydrophilic or hydrophobic modifiers, plasticizers, surface finishers or combinations thereof. Hydrophilic or hydrophobic modifiers are modifiers that either modify the surface in that way that the surface itself receives hydrophilic or hydrophobic properties or in that the modifier carries hydrophilic or hydrophobic properties and remains on the surface after applying the modifier.

In a preferred embodiment the container according to the invention is further characterized in that said container is divided into at least two chambers. All cambers present may contain the same active ingredient or the same veterinary preparation. According to the invention the containers may also contain different active ingredient or different veterinary preparations.

The container according to the invention is advantageously characterized in that said container comprises further an encasement having a texture that is at least soft or bendable or elastic or resilient at ambient temperature.

According to the invention it is especially preferred that said encasement encloses the container partially or totally. In the following description the encasement may also be named as carrier. This is especially in the context of the description of a bait formed out of a container and en encasement according to the present invention.

According to the invention it is especially further preferred that said encasement is covered by a wrapper totally or partially and wherein the wrapper comprises natural compounds or synthetic compounds or synthetically modified natural compounds or combinations thereof.

It is also an object of the present invention that the container according to invention forms a bait for animals. The bait for animals according to the invention contains at least one container according to the invention as described above.

It is preferred according to the invention that two or more containers according to the invention are embedded together in a carrier, wherein the carrier is made from material having a texture that is at least soft or bendable or elastic or resilient at ambient temperature.

An object of the present invention is a bait for animals comprising at least one container surrounded by a carrier, the carrier being made from a material having a texture that is at least soft or bendable or elastic or resilient at ambient temperature and wherein the container surrounded by the carrier is also made from material having a texture that is at least soft or bendable or elastic or resilient at ambient temperature.

The bait according to the invention is further characterized in that in the carrier and/or on the surface of the container at least one additive is present enhancing the cohesion between carrier and container. According to the invention the said additive is selected from hydrophilic or hydrophobic modifiers, plasticizers, surface finisher or combinations thereof. Hydrophilic or hydrophobic modifiers are modifiers that either modify the surface in that way that the surface itself receives hydrophilic or hydrophobic properties or in that the modifier carries hydrophilic or hydrophobic properties and remains on the surface after applying the modifier.

The bait according to the invention is further characterized in that the at least one container is present in form of single isolated container or that two or more containers are present that are isolated or adhered to each other or are physically connected to each other or are connected to each other in form of a chain-like configuration.

The bait according to the invention is further characterized in that the container or the containers incorporate(s) an active therapeutic ingredient and optionally physiologically acceptable additives, adjuvants or excipients or combinations thereof. According to the invention the said active therapeutic ingredient is selected from biologics, contraceptives, pharmaceuticals or veterinary drugs or a combination thereof.

According to the invention it is preferred that at least on additive is a viscosity modifier.

According to the invention it is especially preferred that the container with the active therapeutic ingredient comprises further a palatable acceptable additive selected from sugars, sweeteners, salt, natural flavourings, artificial flavourings or combinations thereof.

According to the invention it is also preferred that the active ingredient incorporated in the container is in form of a high viscous fluid or a paste-like fluid.

It is also preferred according to the present invention that the bait is covered by a casing and wherein the casing comprises natural compounds or synthetic compounds or synthetically modified natural compounds or combinations thereof. The casing may also in the context of the description be named a wrapper.

A further object of the present invention is an assembly of baits comprising a plurality of single baits, wherein the single baits are interconnected to each other forming a chain-like structure of the assembly and wherein the interconnection is provided by a chain-like interconnection of the containers and/or by the interconnection of the single baits wherein the single baits are formed out of a casing that covers the baits and wherein the casing is constricted to form the single bait structure.

Another object of the present invention is the use of a bait according to the present invention for administering an active therapeutic ingredient to an animal.

A further object of the present invention is a method for the production of a container and/or a bait according to the invention, comprising the following steps:
providing at least one container and filling the container with an effective amount of an active therapeutic ingredient and optionally with physiologically acceptable additives, adjuvants or excipients or combinations thereof;
mixing components for the carrier (encasement);
liquefying of the intermixed carrier components by addition of heat and/or solvents;
providing a mould for shaping the liquefied carrier components;
filling the mould with the previously filled container and with the liquefied carrier components;
cooling the mould to ambient temperature by optionally rotating the mould during cooling in order to avoid sedimentation of the container surrounded by the carrier components; and
separating the produced bait from the mould.

A method is preferred according to the invention wherein the at least one provided and/or filled container is present in form of single isolated container or that two or more containers are present that are isolated or adhered to each other or are physically connected to each other or are connected to each other in form of a chain-like configuration.

Especially preferred is a method for the production of a bait according to the invention, comprising an additional step of covering the produced bait with casing.

The bait for animals according to the invention shows the following novel and advantageous properties.

1) The texture of the bait matrix herein referred also as carrier or encasement, is solid but instead of being firm it is soft, bendable, elastic and/or resilient. Baits according to the invention can be prepared from material like gelatine, agar-agar, etc. The bait matrix may be also present in form of a foam surrounding the container.

This kind of texture has the advantage that it will not fall apart during consumption and subsequently that the vaccine container is not as easily separated from the bait matrix.

2) Also, the texture of the container is soft, flexible, bendable and/or resilient. This reduces the risk of active separation by the animals. The outer surface of the container may be advantageously treated in such way that it has increased cohesion with the carrier material thus preventing separation.

3) To reduce spillage of the active therapeutic agent, the formulation of the active therapeutic agent has preferably a high viscosity so that it will not be easily spilled. This can be achieved by the addition of jellying or swelling agents. Suitable additives are swelling agents used in pharmaceuticals like modified cellulose, carboxymethyl cellulose and the like.

4) To enhance uptake of the active therapeutic agent, it may have an attractive taste. An additive (e.g. sucrose or lactose or salt) may be preferably included in the formulation containing the active ingredient that enhances palatability thus increasing contact time or duration of contact with the active ingredient. To achieve this higher levels of palatable ingredients will be added. These levels are higher than those used for preservation and/or stability purposes. The taste is adjusted to the target animal and may be sweet, salty, bitter, sour, or a combination thereof.

5) The bait may according to the invention additionally be surrounded or covered with an external intestine-like husk or peel or wrapper around the bait to improve compactness and non-separation or cohesion properties of the whole bait system. This covering or wrapper is also useful for embedding the vaccine-bait-matrix, for fixation of additional flavours and a guarantee of slow disposal of flavours from the bait matrix and lastly for lowering attractiveness and food consumption by insects and other non-target animals.

In an especially preferred embodiment of the present invention the baits are arranged in an assembly of baits. This means that the single baits are interconnected to each other in order to form a larger size of the bait. This has the advantage that the single baits may be easily separated prior to use. This applies for example when baits are laid out from an aircraft. In this case the assembly may be used in a magazine feeder in order to perform the lay out of the baits automatically. Using the assembly of baits it is also possible to adjust the size of the bait to the target animal. If the size is too big so that the animal can not swallow the bait the animal has to bite the bait in order to reduce the size. In that case the chance is extremely high that a container in the bait is ruptured and that the active therapeutic agent is taken up by the target animal.

The assembly of baits is also advantageous when manufacturing the baits according to the invention. In one possible manufacturing process the containers are interconnected and are covered with the carrier material of the bait using extrusion techniques. In another possible manufacturing process the bait will be formed like a sausage using a gut or intestine as a casing. When filling the gut a container is added to every single bait and the gut is constricted and secured by rotation or by a clip or by thermo sealing and forming the single bait structure. The single baits may then be separated by cutting the casing.

In the context of the present invention the expression “container” is defined as follows and has the following properties. A container is defining a cavity surrounded by a surface. The surface surrounding the cavity comprises of an inner surface being in contact with the contents held by the container and of an outer surface facing to the environment outside the container. The inner surface and the outer surface can be made from the same or different materials. It is also possible to modify the outer surface or to cover the outer surface partly or totally with a suitable material.

The container shall hold any active therapeutic ingredient used in the context of the invention. The container shall protect the active therapeutic ingredient from the ambient in order to maintain the activity of the ingredient. The container may have any suitable shape. The material of the container may be a blister material like polyethylene or polyvinylchloride or the like that is covered with another polymeric material making it suitable for thermo forming and/or thermo sealing. The container may be also in form of a known gelatine capsule. It is also possible that the containers are in form of microcapsules containing the active therapeutic ingredient and that are prepared in a known way in order to achieve a sustained release of the active therapeutic ingredient. It is also possible that the container is present in the form of microspheres that can absorb, incorporate or carry an active ingredient.

Oral administration in the sense of the present invention comprises the uptake of any active ingredient, veterinary preparation, or any other medication through the mouth or the mouth cavity. Suitable for oral administration is any preparation in form of tablets, coated tablets, liquid preparations, emulsions, dispersions and the like. The uptake of the active ingredient is performed via the mouth cavity or the gastrointestinal tract.

The invention is further described referring to the attached figures.

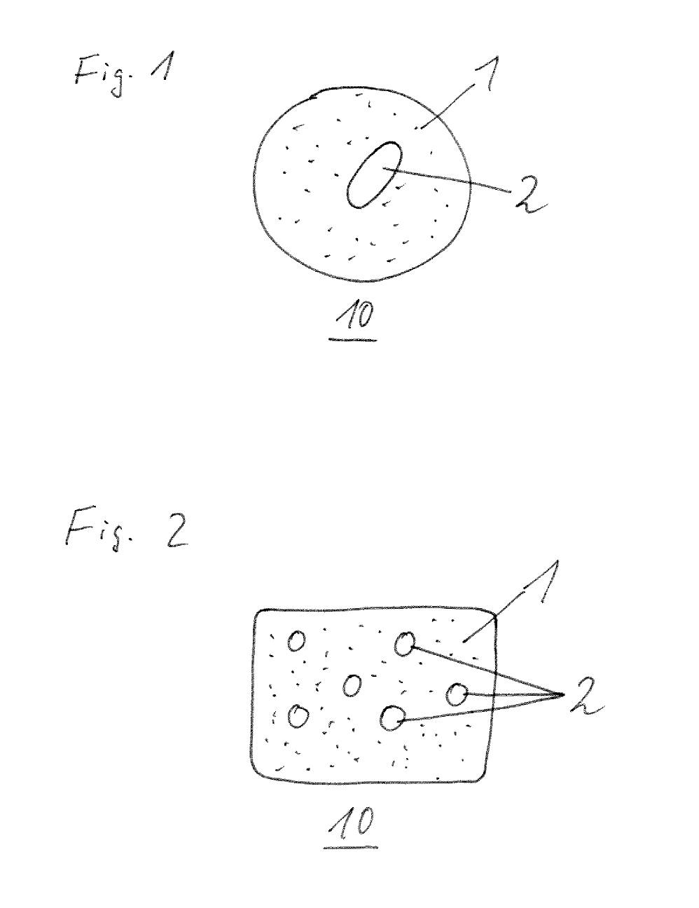

FIG. 1 shows a container 2 according to the invention with an carrier/encasement 1 surrounding the container 2. The form of the resulting bait 10 is mainly spherical.

FIG. 2 shows a bait 10 wherein several containers 2 are surrounded by the carrier/encasement 1.

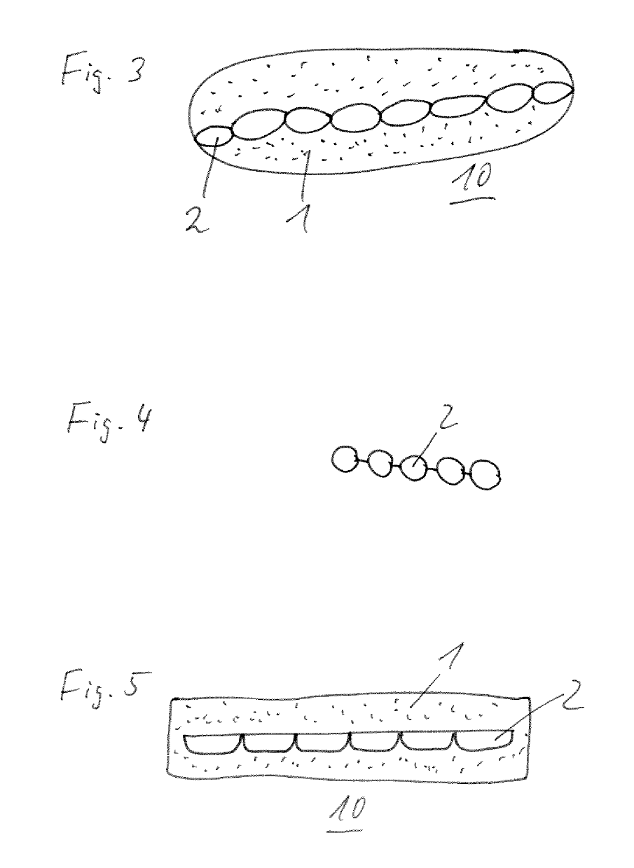

FIG. 3 shows a bait 10 containing containers 2 with several chambers and surrounded by the carrier/encasement 1. In this figure the ends of the outer containers are not necessarily completely surrounded by the carrier/encasement 1.

FIG. 4 shows a chain-like arrangement of containers 2 that are physically adhered to each other.

FIG. 5 shows a bait 10 wherein an arrangement of blisters is completely surrounded by the carrier/encasement 1. The blister forms single and separated containers 2 with several chambers.

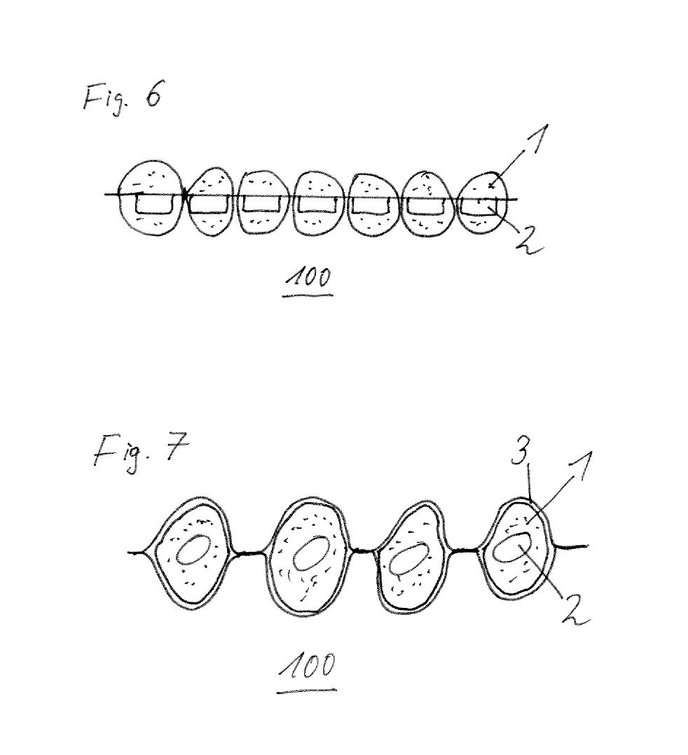

FIG. 6 shows an assembly 100 of baits 10 wherein the containers 2 are interconnected in a chain-like configuration and wherein each single container 2 is surrounded by the encasement/carrier material 1.

FIG. 7 shows an assembly 100 of baits 10 wherein the single baits 10 comprise the container 2 surrounded by the encasement/carrier material 1 and where in the single baits are interconnected by a casing 3 that is in form of a gut or intestine.

The following examples describe the invention in more detail without delimiting the scope of the invention.

### EXAMPLE 1

### Vaccine Formulation

To avoid rapid loss of a liquid active ingredient formulation, which often occurs during uptake and subsequent release of the liquid with water-like viscosity. The aim of reducing spillage of the active ingredient can be achieved by the following three steps (singularly or by combinations of these steps):

1. Improving the taste of the vaccine formulation and thus enhancing the vaccine uptake rate by addition of certain components, for example sugars like sucrose or trehalose or artificial aromas like several meat types. This leads to a taste which can be highly attractive for certain target species and bringing them to a nearly complete uptake of the vaccine. As example, for this purpose the final vaccine formulation contains one of the named sugars in a concentration range of 5-30 volume %.

2. Modifying the viscosity of the vaccine formulation to medium or high viscosity (honey-like, viscosity range 500-10.000 mPas) by adding a jellying ingredient (e.g. gelatine, carboxymethylcellulose, macrogol, polyethylene glycol, PEG or derivatives thereof, and the like) in a suitable concentration range. After release of the active ingredient by for example perforating (biting) the container (e.g. packaging foil) the active ingredient is released preferably inside the mouth of the target animal; due to the higher viscosity and slight stickiness the exposure time is prolonged significantly. This leads to an enhanced uptake rate of the active ingredient and higher vaccination efficacy. Furthermore, the high viscosity will reduce spillage of the active ingredient from the mouth cavity to the environment. A gel-like preparation has the advantage that only active ingredients present at the surface are affected by external substances destroying the activity of the active ingredient (e.g. enzymes from the saliva of the target animals may destroy active ingredients prior to the uptake). Active ingredients inside the gel-like matrix may therefore be protected and stabilized.

3. Addition of 5-30 volume % sugars as taste enhancer and/or stabilizer into 50-70% liquid vaccine virus, afterwards addition of the jellying substance in the respective amounts to obtain the desired viscosity. All ingredients are processed according to manufacturers instruction or other appropriate methods, which are common knowledge.

Recipe for a Sterile Vaccine Formulation with CMC

1. Autoclaving the necessary amount of CMC (Carboxymethyl cellulose) powder (e.g. CMC CRT100 PA, Dow Wolff Chemicals, or comparable) at 121° C., 20 min. in a glass bottle.

2. Weighing the respective amount of sterile CMC powder and transferring the same into a suitable vessel (e.g. roller bottle), filling up with liquid (e.g. PBS or cell culture medium) up to a CMC concentration of 6% (w/v). Agitation of the roller bottle for 18-24 h at 37° C. and 0.22 rpm. Result is a 6% CMC solution with a viscosity of 10.000 mPas.

3. Adding of the respective amount of antigen solution (clarified virus containing cell culture supernatant with defined antigen level—virus titre) to the CMC solution, typical relation is 50% CMC to 50% antigen and mixing for about 0.5 hours. This results in a modified vaccine solution with a desired viscosity of about 5.000-6.000 mPas, which can be further processed for vaccine production. Other ratios of antigen to CMC are possible and easily producible according to the specifications of the vaccine.

### EXAMPLE 2

### Vaccine Capsule Texture

To avoid active breakup or detachment of the container from the encasement by the target animal as a result of the inflexible, solid characteristics of the container material the texture should be non-rigid and flexible. A container with these characteristics can be produced as follows:
The container consists of only one type of foil material. The used foil material is thinner than 70 μm. Such foils could be polyethylene or biodegradable foils in conjunction with metal coating to improve barrier properties.
The manufacture of containers can be run by a blister machine or a stick pack machine or a suppository machine which perform a complete filling without head space.

The container can be effectively opened by the target species either by a brittle consistence of the foil or a sealed seam that can be opened by small pressure of the chewing pressure of the animal.

Containers of that kind may be produced by using Form-Fill-Sealing-Blister-Machines with thermoforming properties. Single thermoformed blisters are formed from a foil thinner than 75 μm and filled with the according vaccine formulation (e.g. according to example 1). The outer side of the sealed container is arranged in that way in order to form a coherent adhesion with the surrounding encasement, carrier or matrix of the bait avoiding that the container and the surrounding matrix can be easily separated by the target animal when biting and chewing the container or the bait.

### EXAMPLE 3

### Production of a Bait

To avoid rapid separation of the container from the encasement or the carrier that often results in a failed attempt of oral uptake of the active ingredient, the texture of the encasement or the carrier should be firm but flexible and slightly compressible to increase chewing intensity and duration. Encasements or carriers with these characteristics can be produced as follows:
The basic ingredients are mixed using the following weight ratios; water—70%, gelatine (Type 73435)—20% and corn starch—10%).
The gelatine is mixed with the water at running tap water temperature and left to swell for 10 minutes. Meanwhile a water bath is prepared with controlled temperature of +97° C. After the gelatine/water mixture has been swelling for 10 minutes and the water bath has reached its designated temperature, the container with the gelatine/water mixture is placed in the water bath until the mixture is liquefied (duration approximately 10-15 minutes).
The container with the mixture is taken from the water bath and the corn starch is added by stirring at a temperature of +90° C.
The material is left to cool down until it reaches a temperature of +47° C.
Two units of milk powder is stirred into 100 units of the above described mixture at +47° C.
This final mixture is then poured into the desired mould at +45° C.
Instead of milk powder other suitable attractants can be added.

### EXAMPLE 4

### Cohesion Enhancing

To avoid rapid separation of the container from the encasement or the carrier it is possible to increase the adhesion between the container and the encasement/carrier. One way to achieve this is by adding glycerine to the encasement/carrier material.

Recipe for a Gelatine Based Carrier with Enhanced Cohesion Properties

140 g purified water and 20 g glycerol (85% w/w) are mixed by stirring with a propeller mixer and heated to 60-70° C. in double-walled flask. 40 g gelatine powder (Imagel AP, Type 73 435) is slowly added to the mixture under stirring until dissolution of the gelatine. Finally a mixture of 60 g fish meal and 60 g cornmeal is added under stirring to form a homogeneous mixture.

The resulting mixture is free-flowing in a temperature range from 50 to 70° C.

The mixture can be used for filling gut or intestine to obtain sausage-like baits or can be used for dip-coating or dip-moulding of containers or for casting baits in moulds.

### EXAMPLE 5

### Cohesion Test

According to example 2 the same bait matrix and capsule was used. During several experimental studies with striped skunks (Mephitis mephitis) the problem with the active detachment of the container from the bait matrix for baits according to the state of the art became evident. Using an experimental bait matrix that was well accepted by the target species and 4 different container types, it was shown that during 44 attempts offering the skunks the baits containing one of the 4 container types not less than 30 (68%) animals separated the container actively from the bait matrix. In most cases the blisters were actively separated from the bait matrix, resulting in a perforation of the container but this did not lead to a prolonged contact with the container and its content. Therefore, in case of an active vaccination attempt, these animals would most likely not have been successfully immunized.

In an additional experiment the same type of containers were prepared using a lamination technique. According to example 2 the same bait matrix and capsule was used but an additional lamination layer was added to the surface of the container foil, this to improve cohesion between container and encasement (bait matrix). In one example the foil was laminated with kraft paper (specific weight app. 100 g/m²). Lamination was performed using an adhesive. In another example the foil was laminated using an adhesive with a non-woven fleece having a specific weight of app. 200 g/m².

The same animals were offered these containers in the same or similar bait matrices. Only 1 (<2%) animal of a total 49 observations was able to separate the blister after 17 seconds from the bait matrix. All other animals perforated the container within the bait matrix and had prolonged exposure to the blue dye incorporated within the container

1. Container for storing veterinary preparations and administering veterinary preparations to a target animal species, wherein the container incorporates the veterinary preparation and wherein the container is adapted to present the container to the target animal species in a way that enhances or optimizes the oral delivery of the veterinary preparation to the target animal species.

2. Container according to claim 1, characterized in that the container is made from material having a texture that is at least soft or bendable or elastic or resilient at ambient temperature.

3. Container according to claim 1, characterized in that the said material is selected from artificial organic or inorganic polymers, biopolymers, modified biopolymers, metals and composites thereof.

4. Container according to claim 1, characterized in that the container has an inner surface intended to be in contact with the veterinary preparation and an outer surface wherein at least a part of the outer surface is modified and/or is made from or covered with a different material than the inner surface.

5. Container according to claim 4, characterized in that the modification of the surface or the different material of the surface causes a change in the surface characteristics, wherein the characteristics are selected from adhesion, cohesion, hardness, roughness, surface feel, optical aspect, odour and/or taste.

6. Container according to claim 1, characterized in that the veterinary preparation is selected from biologics, contraceptives, pharmaceuticals or veterinary drugs or a combination thereof.

7. Container according to claim 6, characterized in that the veterinary preparation comprises optionally physiologically acceptable additives, adjuvants or excipients or combinations thereof.

8. Container according to claim 7, characterized in that at least one additive is a viscosity modifier.

9. Container according to claim 1, characterized in that the veterinary preparation comprises further a palatable acceptable additive selected from sugars, sweeteners, salt, natural flavourings, artificial flavourings or combinations thereof.

10. Container according to claim 1, characterized in that the veterinary preparation is in form of a high viscous fluid or a paste-like fluid.

11. Container according to claim 5, characterized in that the change in the surface characteristics is provided by the addition of a palatable acceptable additive selected from sugars, sweeteners, salt, natural flavourings, artificial flavourings or combinations thereof.

12. Container according to claim 1, characterized in that on the surface of the container at least one component is present enhancing the cohesion.

13. Container according to claim 12, characterized in that said component is selected from hydrophilic or hydrophobic modifiers, plasticizers, surface finisher or combinations thereof.

14. Container according to claim 1, characterized in that the said container is divided into at least two chambers.

15. Container according to claim 1, characterized in that the said container comprises an encasement having a texture that is at least soft or bendable or elastic or resilient at ambient temperature.

16. Container according to claim 15, characterized in that said encasement encloses the container partially or totally.

17. Container according to claim 15, characterized in that said encasement is covered by a wrapper totally or partially and wherein the wrapper comprises natural compounds or synthetic compounds or synthetically modified natural compounds or combinations thereof.

18. A bait for animals containing at least one container according to claim 1.

19. The bait, according to claim 18, characterized in that the at least one container comprises two or more containers and in that the two or more containers are embedded together in a carrier, wherein the carrier is made from material having a texture that is at least soft or bendable or elastic or resilient at ambient temperature.
